(19) United States
(12) Patent Application Publication
(10) Pub. No.: US 2018/0250536 A1
(43) Pub. Date: Sep. 6, 2018

(54) DETACHABLE CONNECTOR

(71) Applicant: SHIGEMATSU WORKS CO., LTD., Tokyo (JP)

(72) Inventors: Nobuo Shigematsu, Tokyo (JP); Kenichi Ono, Saitama (JP); Osamu Zaitsu, Saitama (JP)

(21) Appl. No.: 15/300,050

(22) PCT Filed: Mar. 9, 2016
(86) PCT No.: PCT/JP2016/057441

§ 371 Date: Sep. 28, 2016

(51) Int. Cl. A62B 18/08; A62B 9/04

(52) U.S. Cl. CPC A62B 18/08; A62B 7/10; A62B 9/04

(57) ABSTRACT

[Object of the Invention] An object of the present invention is to provide a detachable connector between a face piece and a filter of a breathing apparatus comprising a bayonet connection mechanism for connecting a pair of members by pushing and twisting operation, wherein detaching of the filter from the face piece by accident or user error is effectively prevented.

[Disclosure of the Invention] A detachable connector between a face piece and a filter of a breathing apparatus is provided with a bayonet connection mechanism for connecting a pair of members by pushing and twisting operation, and a lock mechanism for locking a connection between the pair of members by fitting a pin in a hole provided in an elastic member, wherein connecting motion of the bayonet connection mechanism synchronizes with locking motion of the lock mechanism so that connection of the filter and locking of the connection are carried out simultaneously when the filter is connected to the face piece, while unlocking motion of the lock mechanism precedes disconnecting motion of the bayonet connection mechanism so that unlocking of the connection precedes disconnection of the filter when the filter is disconnected from the face piece.

### TECHNICAL FIELD

The present invention relates to a detachable connector between a face piece and a filter of a breathing apparatus.

### BACKGROUND ART

Patent document No. 1 discloses a detachable connector between a face piece and a filter of a breathing apparatus comprising a bayonet connection mechanism for connecting a pair of members by pushing and twisting operation.

The bayonet connection mechanism comprises a male side member provided with a lug, a female side member provided with a lug or an L-shaped slot and a spring, wherein pushing force is applied to the male side member so as to push the lug of the male side member into the L-shaped slot of the female side member or to the rear near one end of the lug of the female side member, twisting force is applied to the male side member so as to twist the lug of the male side member along the slot or the lug of the female side member, and then the pushing force and the twisting force are released from the male side member so as to force the lug of the male side member against a side surface of the L-shaped slot or a rear surface of the lug of the female side member by means of the biasing force of the spring, thereby connecting the male side member with the female side member. The L-shaped slot of the female side member is provided with a projection near an entrance and the lug of the female side member is provided with a projection near aforesaid one end. The projection extends in the direction of the pushing force applied to the male side member. Thus, the lug of the male side member cannot be released from engagement with the slot or the lug of the female side member by simple twisting of the male side member in the releasing direction.

### PATENT DOCUMENT

Patent Document No.1: Japanese Patent Laid-Open No. 2014-533553

### DISCLOSURE OF INVENTION

### Problem to Be Solved

The male side member can be pushed into the female side member and twisted in the releasing direction by accident or error of a user of the breathing apparatus.

An object of the present invention is to provide a detachable connector between a face piece and a filter of a breathing apparatus comprising a bayonet connection mechanism for connecting a pair of members by pushing and twisting operation, wherein detaching of the filter from the face piece by accident or user error is effectively prevented.

### Means for Achieving the Object

In accordance with the present invention, there is provided a detachable connector between a face piece and a filter of a breathing apparatus comprising a bayonet connection mechanism for connecting a pair of members by pushing and twisting operation, and a lock mechanism for locking a connection between the pair of members by fitting a pin in a hole provided in an elastic member, wherein connecting motion of the bayonet connection mechanism synchronizes with locking motion of the lock mechanism so that connection of the filter and locking of the connection are carried out simultaneously when the filter is connected to the face piece, while unlocking motion of the lock mechanism precedes disconnecting motion of the bayonet connection mechanism so that unlocking of the connection precedes disconnection of the filter when the filter is disconnected from the face piece.

In the detachable connector of the present invention, unlocking motion of the lock mechanism precedes disconnecting motion of the bayonet connection mechanism when the filter is disconnected from the face piece. That is, disconnection operation of the filter from the face piece requires two releasing motions independent of each other. Thus, detaching of the filter from the face piece by accident or user error is effectively prevented.

In accordance with a preferred aspect of the present invention, the elastic member of the lock mechanism is a band shaped body fixed at opposite ends and provided with radially outward bulges near the opposite ends and the hole is located at the longitudinal middle of the band shaped body, and wherein the pin of the lock mechanism opposes one of the radially outward bulges of the band shaped body at an initial stage of connecting motion of the bayonet connection mechanism, moves relatively to the band shaped body to the longitudinal middle of the band shaped body synchronously with progress of the connecting motion of the bayonet connection mechanism, and fits in the hole of the band shaped body at the completion of the connecting motion of the bayonet connection mechanism, while the pin is released from the hole when the radially outward bulges near the opposite ends of the band shaped body are forced radially inward so that the longitudinal middle of the band shaped body projects radially outward.

It requires a rather complicated action to force the radially outward bulges near the opposite ends of the band shaped body radially inward so as to make the longitudinal middle of the band shaped body bulge radially outward, thereby releasing the pin from the hole. Therefore, the aforesaid action is not likely to occur by accident or user error. Thus, detaching of the filter from the face piece by accident or user error is effectively prevented.

In accordance with a preferred aspect of the present invention, the elastic member of the lock mechanism is attached to the filter and the pin of the lock mechanism is attached to the face piece.

In accordance with a preferred aspect of the present invention, the elastic member of the lock mechanism is attached to the face piece and the pin of the lock mechanism is attached to the filter.

Relative position relationship between the elastic member and the pin of the lock mechanism can be either of the two described above.

In accordance with the present invention, there is provided a face piece of a breathing apparatus comprising any one of the aforesaid detachable connectors.

In the face piece of a breathing apparatus of the present invention, detaching of the filter from the face piece by accident or user error is effectively prevented.

### BRIEF DESCRIPTION OF THE DRAWINGS

FIG. 1 is a front view of a full face piece comprising a detachable connector in accordance with a preferred embodiment of the present invention, shown at the start of the connecting operation of the filter.

FIG. 2 is a set of views of external appearance of a detachable connector in accordance with a preferred embodiment of the present invention, shown at the start of the connecting operation of the filter. (a) is a side view, (b) is a view in the direction of arrows b-b in (a), and (c) is a view in the direction of arrows c-c in (b).

FIG. 3 is a front view of a full face piece comprising a detachable connector in accordance with a preferred embodiment of the present invention, shown at the completion of the connecting operation of the filter.

FIG. 4 is a set of views of external appearance of a detachable connector in accordance with a preferred embodiment of the present invention, shown at the completion of the connecting operation of the filter. (a) is a side view, (b) is a view in the direction of arrows b-b in (a) and (c) is a view in the direction of arrows c-c in (b).

FIG. 5 is an exploded perspective view of a bayonet connection mechanism provided for a detachable connector in accordance with a preferred embodiment of the present invention, shown just before the start of the connecting operation of the filter.

### MODES FOR CARRYING OUT THE INVENTION

A detachable connector in accordance with a preferred embodiment of the present invention will be described.

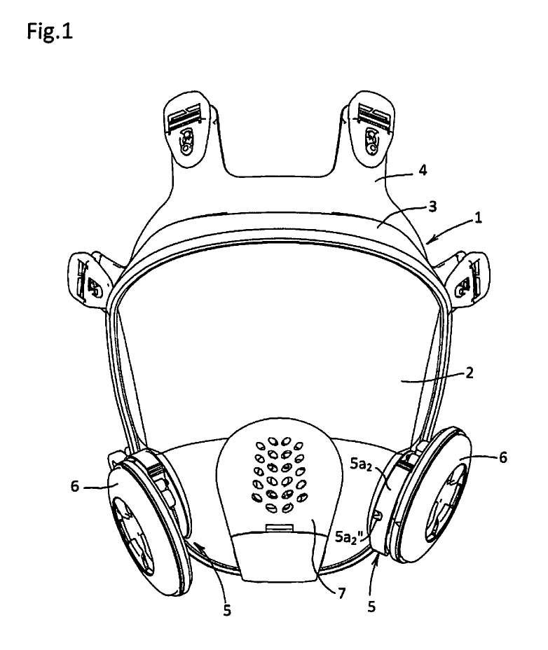

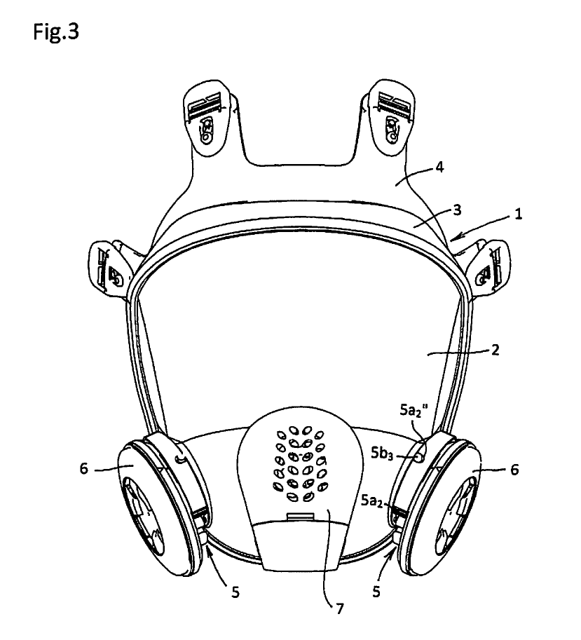

As shown in FIGS. 1 and 3, a full face piece 1 of a breathing apparatus comprises an visor 2 for covering a front part and both side parts of the face of a user of the breathing apparatus. The visor 2 is made of transparent hard plastic material. The full face piece 1 further comprises a main body 3 integrally united with a circumference of the visor 2 so as to cover a circumferential part of the face of the user. The main body 3 is made of flexible elastic material. The full face piece 1 further comprises fastening band connections 4 integrally formed with the main body 3, a pair of filters 6, each of which is connected to a lower side part of the visor 2 through a detachable connector 5, and a protection cover 7 connected to a lower front part of the visor 2 so as to protect an exhale valve and a voice conductor not shown in FIGS. 1 and 3. The fastening band connections 4 are connected to fastening bands for attaching the full face piece 1 to the head of the user. The fastening bands are not shown in FIGS. 1 and 3.

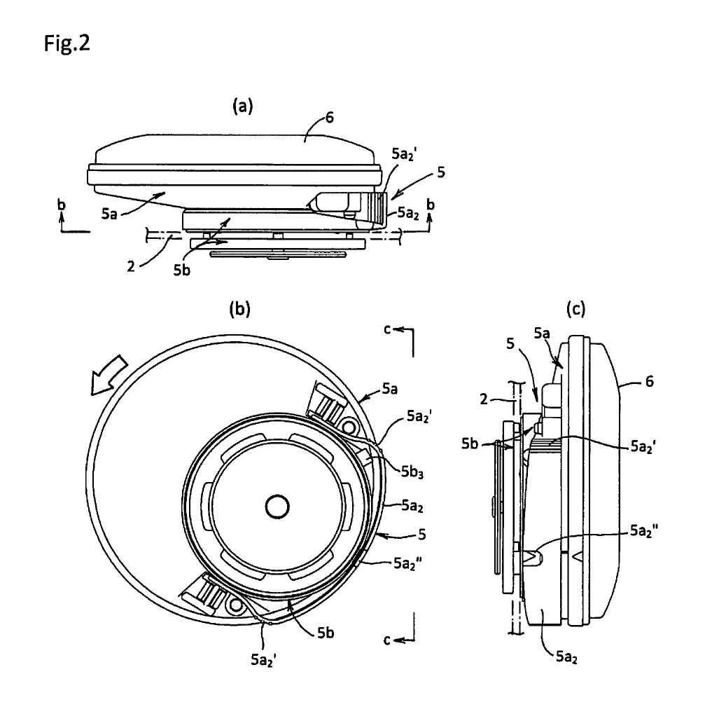

As shown in FIGS. 2, 4 and 5, the detachable connector 5 comprises an annular shaped first part 5a forming a half body of a casing of the filter 6 close to the visor 2 and an annular shaped second part 5b integrally united with the visor 2.

The first part 5a comprises three lugs 5a₁ of a male part of a bayonet connection mechanism disposed at the center portion of the annular shape. The three lugs 5a₁ are disposed annularly and intermittently. The first part 5a further comprises an elastic member 5a₂ of a lock mechanism disposed radially outside the lugs 5a₁. The elastic member 5a₂ is a curved band shaped body made of elastic material which extends along the external circumferential surface of the second part 5b of the detachable connector 5 when the first part 5a and the second part 5b are connected to each other. The elastic member 5a₂ is fixed to the first part 5a of the detachable connector 5 at both longitudinal ends. The elastic member 5a₂ is provided with radially outward bulges 5a₂′ near the opposite ends and a hole 5a₂″ at the longitudinal middle. Radius of curvature of the radially outward bulges 5a₂′ is set smaller than that of the external circumference of the annular second part 5b of the detachable connector 5, while radius of curvature of a longitudinal middle part of the elastic member 5a₂ is set larger than that of the external circumference of the annular second part 5b of the detachable connector 5.

The second part 5b comprises three lugs 5b₁ of a female part of the bayonet connection mechanism disposed at the center portion of the annular shape. The three lugs 5b₁ are disposed annularly and intermittently. The second part 5b further comprises an annular shaped packing 5b₂ made of flexible elastic material and disposed radially outside the lugs 5b₁. The packing 5b₂ forms a spring. The second part 5b further comprises a pin 5b₃ of the lock mechanism disposed on the external circumferential surface. Each of the lugs 5b₁ is provided with a small projection 5b₁′ at one longitudinal end and a large projection 5b₁″ at the other longitudinal end. The projections 5b₁′ and 5b₁″ extend in the push-in direction of the male side member.

Operation of the detachable connector 5 will be described.

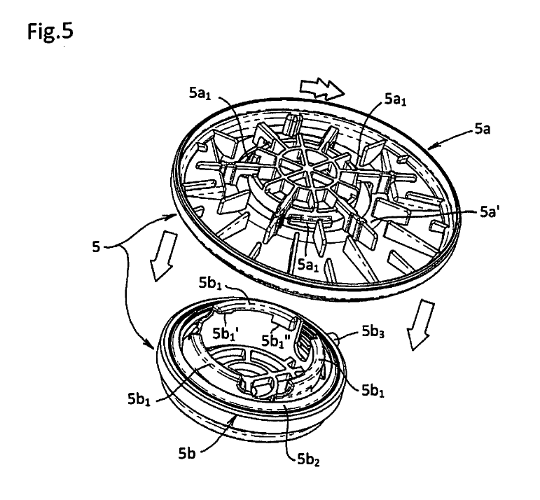

When a user of the breathing apparatus connects the filter 6 to the visor 2, the user holds the filter 6 in the hand, and as shown in FIG. 5, brings the three lugs 5a₁ of the male side member of the bayonet connection mechanism provided in the first part 5a opposite three annularly and intermittently disposed spaces between the three annularly and intermittently disposed lugs 5b₁ of the female side member of the bayonet connection mechanism provided in the second part 5b.

Then, the user moves the first part 5a in the direction indicated by blank arrows in FIG. 5 so as to abut an internal flat annular part 5a′ of a bottom plate of the first part 5a against the annular packing 5b₂ of the bayonet connection mechanism provided in the second part 5b. The pin 5b₃ of the lock mechanism opposes one of the radially outward bulges 5a₂′ of the band shaped elastic member 5a₂ from radially inside with a radial space between them. Therefore, the pin 5b₃ does not obstruct approach of the first part 5a toward the second part 5b. The band shaped elastic member 5a₂ comes close to the external circumferential surface of the annular shaped second part 5b from radially outside at longitudinal middle.

Then, the user forces the first part 5a to abut the second part 5b, while compressing the annular packing 5b₂, so as to push the three lugs 5a₁ of the male side member of the bayonet connection mechanism into the three annularly and intermittently disposed spaces between the three annularly and intermittently disposed lugs 5b₁ of the female side member of the bayonet connection mechanism. Thus, the detachable connector 5 enters a state at the start of the connecting operation of the filter as shown in FIGS. 1 and 2. As aforesaid, the pin 5b₃ of the lock mechanism opposes one of the radially outward bulges 5a₂′ of the band shaped elastic member 5a₂ from radially inside with a radial space between them and the band shaped elastic member 5a₂ comes close to the external circumferential surface of the annular shaped second part 5b from radially outside at longitudinal middle.

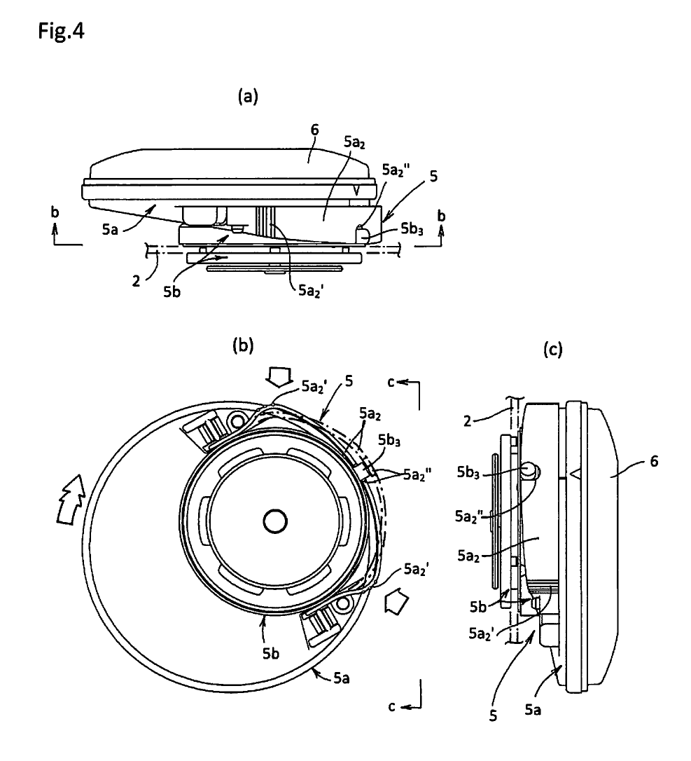

Then, the user twists the first member 5a in the direction indicated by a blank double arrow in FIG. 5 and by a blank arrow in FIG. 2, while keeping the male side member of the bayonet connection mechanism at a position pushed into the female side member. The three lugs 5a₁ of the male side member pass over the small projections 5b₁′ of the three lugs 5b₁ of the female side member and move in the extending direction of the three lugs 5b₁ with upper surfaces opposite lower surfaces of the three lugs 5b₁ of the female side member when viewed in FIG. 5, collide with the large projections 5b₁″, and stop. The pin 5b₃ of the lock mechanism moves together with the movement of the lugs 5a₁ and relatively to the band shaped elastic member 5a₂ toward the longitudinal middle of the band shaped elastic member 5a₂, while expanding the band shaped elastic member 5a₂ radially outward and reaches the hole 5a₂″. Thus, the detachable connector 5 enters a state at the completion of the connecting operation of the filter as shown in FIGS. 3 and 4. The pin 5b₃ fits in the hole 5a₂″ at the longitudinal middle of the band shaped elastic member 5a₂. When the user releases a hand from the filter 6, the three lugs 5a₁ of the male side member are forced against the lower surfaces of the three lugs 5b₁ of the female side member at upper surfaces when viewed in FIG. 5 under biasing force from the annular packing 5b₂. Thus, the male side member and the female side member of the bayonet connection mechanism are connected to each other, the first part 5a and the second part 5b of the detachable connector 5 are connected to each other, and the filter 6 is connected to the visor 2. The pin 5b₃ fits in the hole 5a₂″ at the longitudinal middle of the band shaped elastic member 5a₂. Thus, connection between the first part 5a and the second part 5b of the detachable connector is locked and the connection of the filter 6 with the visor 2 is locked.

When the user wants to undo the connection between the filter 6 and the visor 2 so as to detach the filter 6 from the visor 2, the user, as shown in FIG. 4(b), pushes the radially outward bulges 5a₂′ near the opposite ends of the band shaped elastic body 5a₂ radially inward as indicated by blank arrows so as to project the longitudinal middle of the band shaped body 5a₂ radially outward as indicated by dashed line, thereby releasing the pin 5b₃ from the hole 5a₂″ located at the longitudinal middle of the band shaped elastic body 5a₂ so as to undo the lock of the connection between the first part 5a and the second part 5b of the detachable connector.

As aforesaid, each of the lugs 5b₁ is provided with a small projection 5b₁′ extending in the push-in direction of the male side member at one longitudinal end. Therefore, even if the lock is released, the user cannot release the lugs 5a₁ of the male side member of the bayonet connection mechanism from the lugs 5b₁ of the female side member of the bayonet connection mechanism only by twisting the first part 5a comprising the male side member of the bayonet connection mechanism in the releasing direction.

Therefore, the user twists the first part 5a in the direction as indicated by a blank double arrow in FIG. 4(b), while pushing the radially outward bulges 5a₂′ near opposite of ends the band shaped elastic member 5a₂ radially inward as indicated by blank arrows and pushing the first part 5a or the male side member of the bayonet connection mechanism toward the second part 5b or the female side member of the bayonet connection mechanism. The three lugs 5a₁ of the male side member pass over the small projections 5b₁′ of the three lugs 5b₁ of the female side member, move in the extending direction of the three lugs 5b₁, and reach the three annularly and intermittently disposed spaces between the three annularly and intermittently disposed lugs 5b₁ of the female side member of the bayonet connection mechanism. Then the user stops pushing the radially outward bulges 5a₂′ near the opposite ends of the band shaped elastic body 5a₂ radially inward. As a result, connection between the male side member and the female side member of the bayonet connection mechanism is undone and the detachable connector returns to the state at the start of the connecting operation of the filter as shown in FIGS. 1 and 2.

Then, the user moves the first part 5a in the direction opposite to that indicated by the blank arrows in FIG. 5 so as to release the first part 5a from the second part 5b. As a result, the filter 6 is detached from the visor 2.

In the detachable connector 5, unlocking motion of the lock mechanism precedes disconnecting motion of the bayonet connection mechanism when the filter 6 is disconnected from the visor 2. That is, disconnection operation of the filter 6 from the visor 2 needs two releasing motions independent of each other. Thus, detaching of the filter 6 from the visor 2 by accident or user error is effectively prevented.

It requires a rather complicated action to force the radially outward bulges 5a₂′ near the opposite ends of the band shaped body 5a₂ radially inward so as to make the longitudinal middle of the band shaped body 5a₂ project radially outward, thereby releasing the pin 5b₃ from the hole 5a₂″. Therefore, the aforesaid procedure is not likely to occur by accident or user error. Thus, detaching of the filter 6 from the visor 2 by accident or user error is effectively prevented.

As a result, detaching of the filter 6 from the visor 2 by accident or user error is effectively prevented in the full face piece 1 of the breathing apparatus.

In the aforesaid preferred embodiment, the band shaped elastic member 5a₂ of the lock mechanism is attached to the filter 6 and the pin 5b₃ of the lock mechanism is attached to the visor 2 of the face piece. It is possible instead to attach the band shaped elastic member 5a₂ of the lock mechanism to the visor 2 of the face piece and attach the pin 5b₃ of the lock mechanism to the filter 6.

The face piece for which the detachable connector 5 is used is not restricted to the full face piece. The detachable connector 5 can be used for a half face piece which covers only the user's mouth and nose.

### INDUSTRIAL APPLICABILITY OF THE INVENTION

The present invention can be widely used for a detachable connector between a face piece and a filter of a breathing apparatus comprising a bayonet connection mechanism for connecting a pair of members by pushing and twisting operation.

### EXPLANATION OF REFERENCE NUMERALS

1 Full face piece
2 Visor
3 Main body
4 Fastening band connection
5 Detachable connector
5a First part
5₁ Lug of male side member of bayonet connection mechanism
5a₂ Band shaped elastic member
5a₂′ Radially outward bulge
5a₂″ Hole
5b Second part
5b₁ Lug of female side member of bayonet connection mechanism
5b₁′ Small projection
5b₁″ Largel projection
5b₂ Packing of bayonet connection mechanism
5b₃ Pin
6 Filter
7 Protection cover

1. A detachable connector between a face piece and a filter of a breathing apparatus comprising a bayonet connection mechanism for connecting a pair of members by pushing and twisting operation, and a lock mechanism for locking a connection between the pair of members by fitting a pin in a hole provided in an elastic member, wherein connecting motion of the bayonet connection mechanism synchronizes with locking motion of the lock mechanism so that connection of the filter and locking of the connection are carried out simultaneously when the filter is connected to the face piece, while unlocking motion of the lock mechanism precedes disconnecting motion of the bayonet connection mechanism so that unlocking of the connection precedes disconnection of the filter when the filter is disconnected from the face piece.

2. A detachable connector of claim 1, wherein the elastic member of the lock mechanism is a band shaped body fixed at opposite ends and provided with radially outward bulges near the opposite ends and the hole is located at the longitudinal middle of the band shaped body, and wherein the pin of the lock mechanism opposes one of the radially outward bulges of the band shaped body at an initial stage of connecting motion of the bayonet connection mechanism, moves relatively to the band shaped body to longitudinal middle of the band shaped body synchronously with progress of the connecting motion of the bayonet connection mechanism, and fits in the hole of the band shaped body at the completion of the connecting motion of the bayonet connection mechanism, while the pin is released from the hole when the radially outward bulges near the opposite ends of the band shaped body are forced radially inward so that the longitudinal middle of the band shaped body projects radially outward.

3. A detachable connector of claim 1, wherein the elastic member of the lock mechanism is attached to the filter and the pin of the lock mechanism is attached to the face piece.

4. A detachable connector of claim 1, wherein the elastic member of the lock mechanism is attached to the face piece and the pin of the lock mechanism is attached to the filter.

5. A face piece of a breathing apparatus comprising a detachable connector of claim 1.
